(19) United States
(12) Patent Application Publication
(10) Pub. No.: US 2006/0279520 A1
(43) Pub. Date: Dec. 14, 2006

(54) Display apparatuses and methods for color temperature adjustment thereof

(75) Inventor: Min-Jye Chen, Miaoli (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/452,657

(22) Filed: Jun. 13, 2006

(30) Foreign Application Priority Data
Jun. 14, 2005 (TW) TW094119620

(51) Int. Cl. G09G 3/36

(52) U.S. Cl. 345/102

(57) ABSTRACT

A method for color temperature adjustment. A first color temperature parameter and a second color temperature parameter are acquired. It is determined whether the difference between the first and second color temperature parameters falls into an acceptable range. When the difference between the first and second color temperature parameters falls into the acceptable range, a first voltage value corresponding to a voltage level currently directed to a backlight module of a display apparatus is stored in a storage device of the display apparatus.

### BACKGROUND

The present invention relates to display apparatuses, and more particularly, to display apparatuses and methods for color temperature adjustment thereof.

Conventional liquid crystal panels (LCDs) adjust color temperature by adjusting RGB parameter ratios to scalar ICs via micro-processing units (MPUs). Conventional methods, however, which perform color temperature adjustment through RGB parameter ratios of all signals flowed in scalar ICs, incur greater computational cost.

### SUMMARY

Methods for color temperature adjustment are provided. An embodiment of a color temperature adjustment method is described in the following. A first color temperature parameter and a second color temperature parameter are acquired. It is determined whether the difference between the first and second color temperature parameters falls into an acceptable range. When the difference between the first and second color temperature parameters falls into the acceptable range, a first voltage value corresponding to a voltage level currently directed to a backlight module of a display apparatus is stored in a storage device thereof. After completion of the entire color temperature adjustment, when the display apparatus powers on, a voltage level corresponding to the stored voltage value is directed to the backlight module.

In an aspect, a second voltage value may be further determined contingent upon the difference between the first and second color temperature parameters when the difference between the first and second color temperature parameters does not fall into the acceptable range. A voltage level corresponding to the second voltage value may be directed to the backlight module of the display apparatus.

In an aspect, the first color temperature parameter may correspond to a color temperature flag, indicating that images with a particular color temperature type are displayed. The color temperature flag corresponding to the first voltage value may be stored in the storage device of the display apparatus.

A machine-readable storage medium storing a computer program which, when executed by a processing unit, performs the method of color temperature adjustment is also disclosed.

Display apparatuses for color temperature adjustment are provided. An exemplary embodiment of a display apparatus comprises a backlight module, a storage apparatus and a processing unit. The storage module stores a first voltage level. The processing unit, coupled to the backlight module and the storage device, acquires the first voltage value and directs a voltage level corresponding to the voltage value to the backlight module.

In an aspect, the processing unit may further acquire a first color temperature parameter and a second color temperature parameter and determine whether the difference between the first and second color temperature parameters falls into an acceptable range. When the difference between the first and second color temperature parameters falls into the acceptable range, the first voltage value corresponding to the voltage level currently directed to the backlight module is stored in the storage device. The processing unit may further determine a second voltage value contingent upon the difference between the first and second color temperature parameters when the difference between the first and second color temperature parameters does not fall into the acceptable range, and direct a voltage level corresponding to the second voltage value to the backlight module. When a voltage level corresponding to the second voltage value is directed to the backlight module, a new color temperature parameter detected from the display apparatus will ideally be closer to the second color temperature parameter than the first.

In an aspect, the first color temperature parameter corresponds to a color temperature flag, indicating that images with a particular color temperature type are displayed. The processing unit may store the color temperature flag in the storage device, the color temperature flag corresponding to the first voltage value.

The first and second color temperature parameters may be measured by CIE chromaticity coordinates. The first color temperature parameter may represent color temperature detected by a color temperature metrology apparatus, and the second color temperature parameter may represent a base color temperature.

The backlight module may be composed of multiple white light-emitting diodes (LEDs), and the first voltage value corresponds to the voltage level currently directed to the white LEDs. The backlight module may be composed of multiple red, green and blue LEDs, and the first voltage value comprising three sub-voltage values correspond to voltage levels currently directed to the red, green and blue LEDs.

### DESCRIPTION OF THE DRAWINGS

The invention will become more fully understood by referring to the following detailed description of embodiments with reference to the accompanying drawings, wherein:

FIG. 1 is a diagram of system architecture of an embodiment of a color temperature adjustment system;

FIG. 2 is a diagram of the system architecture of an embodiment of a liquid crystal display (LCD);

FIG. 3 is a diagram of a hardware environment applicable to an embodiment of a computer;

FIG. 4 is a flowchart illustrating an embodiment of a method for color temperature adjustment performed by a micro-processing unit of a LCD apparatus;

FIG. 5 is a diagram of a storage medium storing a computer program for color temperature adjustment;

FIG. 6 is a flowchart illustrating an embodiment of a method for color temperature adjustment performed by a processing unit of a computer;

FIG. 7 is a diagram of a storage medium storing a computer program for color temperature adjustment.

### DETAILED DESCRIPTION

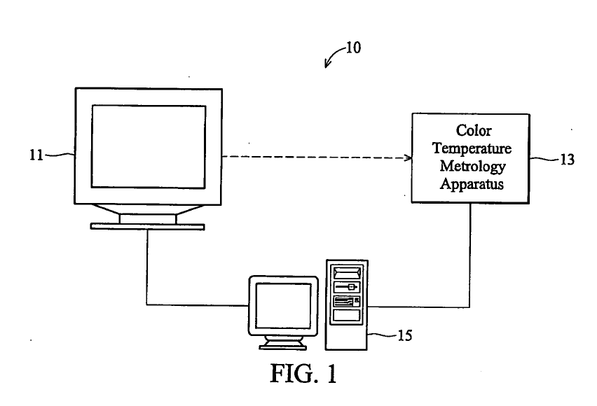

FIG. 1 is a diagram of system architecture of an embodiment of a color temperature adjustment system 10, comprising a liquid crystal display (LCD) 11, a color temperature metrology apparatus 13 and a computer 15. Those skilled in the art will recognize that the color temperature metrology apparatus 13 is connected to the computer 15, and the computer 15 is connected to the LCD 11 via various types of connectors.

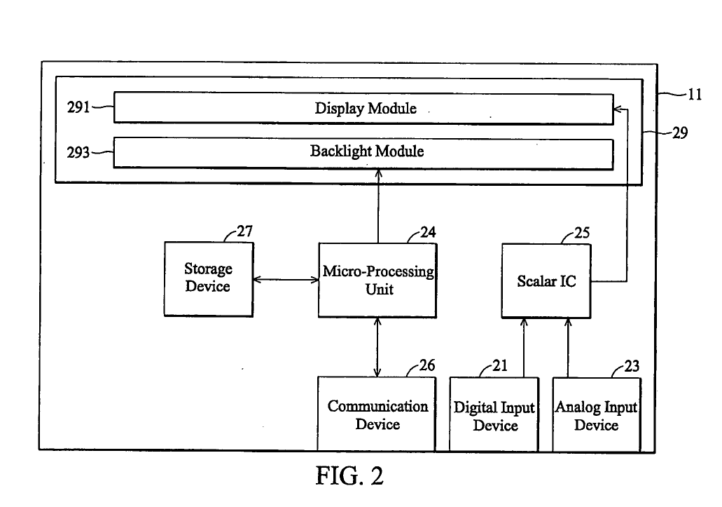

FIG. 2 is a diagram of the system architecture of an embodiment of the LCD 11. The LCD apparatus 11 comprises a digital input device 21, an analog input device 23, a micro-processing unit 24, a scalar IC 25, a communication device 26, a storage device 27 and a LCD panel 29. Moreover, those skilled in the art will understand that some embodiments may be practiced with other display configurations. The LCD panel 29 comprises a display module 291 and a backlight module 293. The backlight module 293 may be composed of white light-emitting diode (LED), or red, green and blue LEDs to generate backlight. The storage device 27, such as random access memory (RAM), read-only memory (ROM), flash memory, or similar, stores program modules executed by the micro-processing unit 24 to perform color temperature adjustment. The scalar IC 25 receives R, G and B signals via the digital input device 21 or analog input device 23, and accordingly controls the display module 291 to display specific images. R, G, B signals provide color information for all pixels in an image. The micro-processing unit 24 may acquire a voltage value stored in the storage device 27 to direct a voltage level corresponding to the acquired voltage value to the backlight module 293, enabling the LCD 11 to display images with a particular color temperature. The storage device may store multiple voltage records respectively comprising a color temperature type such as reddish, blueish and the like, and a voltage value corresponding to the color temperature type. The micro-processing unit 24 acquires a color temperature type configured in the On-Screen Display (OSD), and accordingly acquires a voltage value in a specific voltage record and directs a voltage level corresponding to the acquired voltage value to the backlight module 293, enabling the LCD 11 to display images with a particular color temperature.

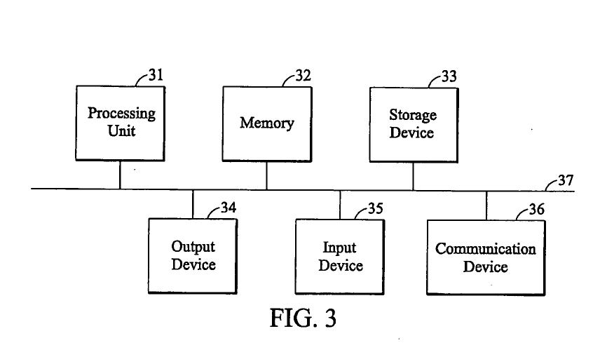

FIG. 3 is a diagram of a hardware environment applicable to an embodiment of computer 15, comprising a processing unit 31, memory 32, a storage device 33, an output device 34, an input device 35 and a communication device 36. They are connected by various bus architectures 37. Moreover, those skilled in the art will understand that some embodiments may be practiced with other computer system configurations, including handheld devices, multiprocessor-based, microprocessor-based or programmable consumer electronics, network PCs, minicomputers, mainframe computers, or similar. There may be one or more processing units 31, such that the processor of the computer comprises a single central processing unit (CPU), a micro-processing unit (MPU) or multiple processing units, commonly referred to as a parallel processing environment. The memory 32 is preferably a random access memory (RAM), but may also include read-only memory (ROM) or flash memory. The memory 32 preferably stores program modules executed by the processing unit 31 to perform color temperature adjustment. Generally, program modules include routines, programs, objects, components, or others, that perform particular tasks or implement particular abstract data types. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web objects, Web Services or other similar architectures.

While the backlight module 293 in the LCD 11 generates backlight, the color temperature metrology apparatus 13 periodically detects the color temperature of images on the LCD 11 and transmits corresponding color temperature parameters to the computer 15. The detected color temperature parameter is preferably measured by CIE chromaticity coordinates.

Some embodiments of the computer 15 may periodically acquire the detected and transmit color temperature parameter from the color temperature metrology apparatus 13 to the micro-processing unit 24 in the LCD apparatus 11.

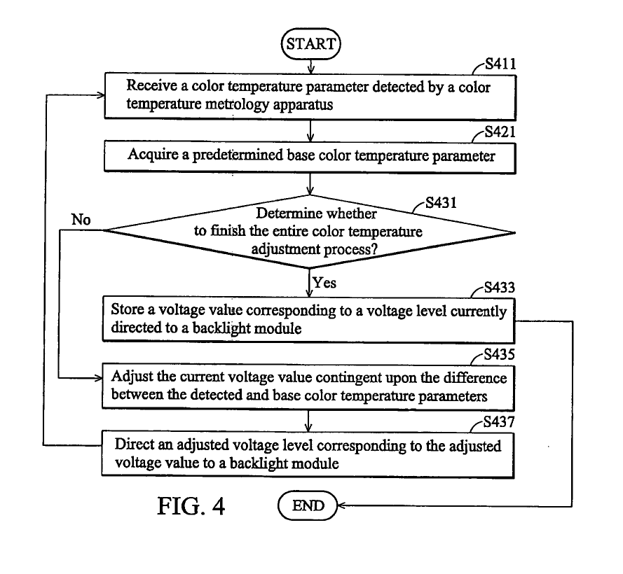

FIG. 4 is a flowchart illustrating an embodiment of a method for color temperature adjustment performed by the micro-processing unit 24 of the LCD apparatus 11. In step S411, a color temperature parameter detected by the color temperature metrology apparatus 13 is received from the computer 15. In step S421, a predetermined base color temperature parameter is acquired. In step S431, it is determined whether to finish the entire color temperature adjustment process contingent upon the difference between the detected and base color temperature parameters. Step S431 determines whether the difference between the detected and base color temperature parameters falls into an acceptable range, and, if so, the process proceeds to step S433, and otherwise, to step S435. In step S433, a voltage value corresponding to a voltage level currently directed to the backlight module 293 is stored in the storage device 27. After the completion of the entire method, when the LCD apparatus 11 powers on, the stored voltage value will be acquired, and subsequently, a voltage level corresponding to the acquired voltage value is directed to the backlight module 293 to generate the desired color temperature. Note that, if the backlight module 293 is composed of white LEDs, the stored voltage value corresponds to a voltage level directed to white LEDs, and otherwise, if the backlight module 293 is composed of red, green and blue LEDs, three voltage levels respectively corresponding to three voltage values are directed to red, green and blue LEDs. In step S435, the current voltage value is adjusted contingent upon the difference between the detected and base color temperature parameters. In step S437, an adjusted voltage level corresponding to the adjusted voltage value is directed to the backlight module 293. When the adjusted voltage level is directed to the backlight module 293, a new color temperature parameter detected by the color temperature metrology apparatus 13 will ideally be closer to the base color temperature parameter than the previously detected color temperature parameter.

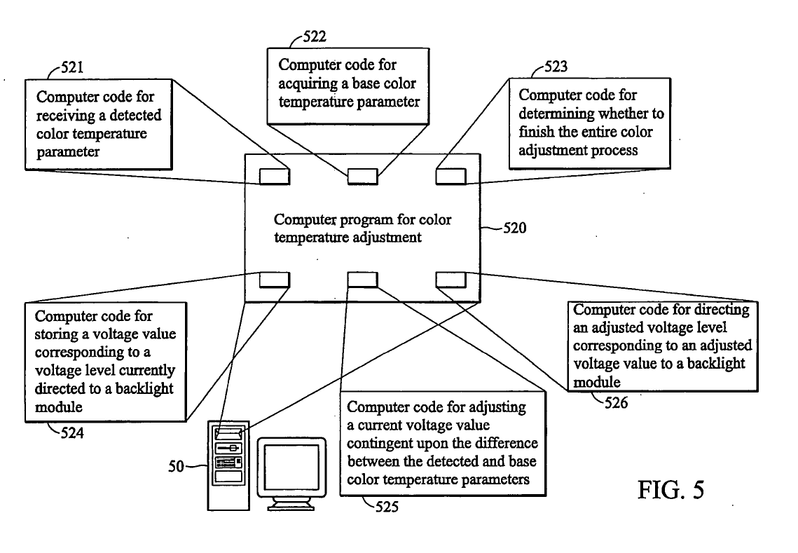

Also disclosed is a storage medium as shown in FIG. 5 storing a computer program 520 providing the disclosed methods of color temperature adjustment. The computer program includes a storage medium 50 having computer readable program code therein for use in a computer system. The computer readable program code comprises at least computer readable program code 521 for receiving a detected color temperature parameter, computer readable program code 522 for acquiring a base color temperature parameter, computer readable program code 523 for determining whether to finish the entire color adjustment process, computer readable program code 524 for storing a voltage value corresponding to a voltage level currently directed to a backlight module, computer readable program code 525 for adjusting a current voltage value contingent upon the difference between the detected and base color temperature parameters, and computer readable program code 526 for directing an adjusted voltage level corresponding to an adjusted voltage value to a backlight module.

Some embodiment of computer 15 may periodically acquire the detected color temperature parameter from the color temperature metrology apparatus 13.

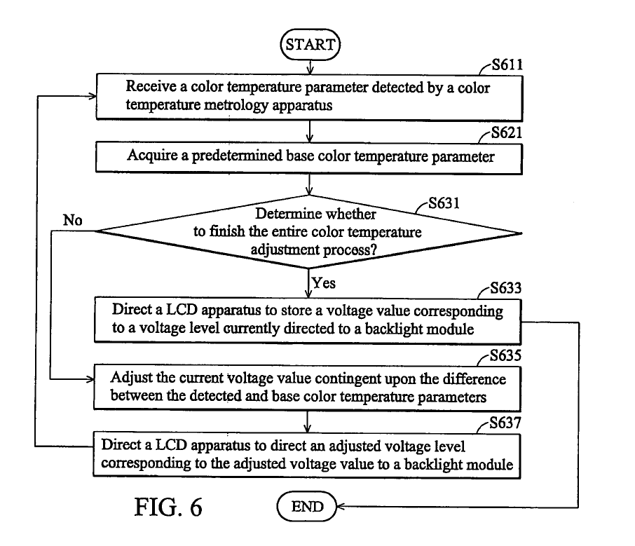

FIG. 6 is a diagram illustrating a flowchart of an embodiment of a method for color temperature adjustment performed by the processing unit 31 of the computer 15. In step S611, a color temperature parameter is received from the color temperature metrology apparatus 13. In step S621, a predetermined base color temperature parameter is acquired. In step S631, it is determined whether to finish the entire color temperature adjustment process contingent upon the difference between the detected and base color temperature parameters. Step S631 determines whether the difference between the detected and base color temperature parameters falls into an acceptable range, and, if so, the process proceeds to step S633, and otherwise, to step S635. In step S633, a command is issued to the micro-processing unit 24 of the computer 15 to store a voltage value corresponding to a voltage level currently directed to the backlight module 293 in the storage device 27 thereof. After the completion of the entire method, when the LCD apparatus 11 powers on, the stored voltage value will be acquired, and subsequently, a voltage level corresponding to the acquired voltage value is directed to the backlight module 293 to generate the previously adjusted color temperature. In step S635, the current voltage value is adjusted contingent upon the difference between the detected and base color temperature parameters. In step S637, a command is issued to the micro-processing unit 24 of the computer 15 to direct an adjusted voltage level corresponding to the adjusted voltage value to the backlight module 293. When the adjusted voltage level is directed to the backlight module 293, a new color temperature parameter detected by the color temperature metrology apparatus 13 will ideally be closer to the base color temperature parameter than the previously detected color temperature parameter.

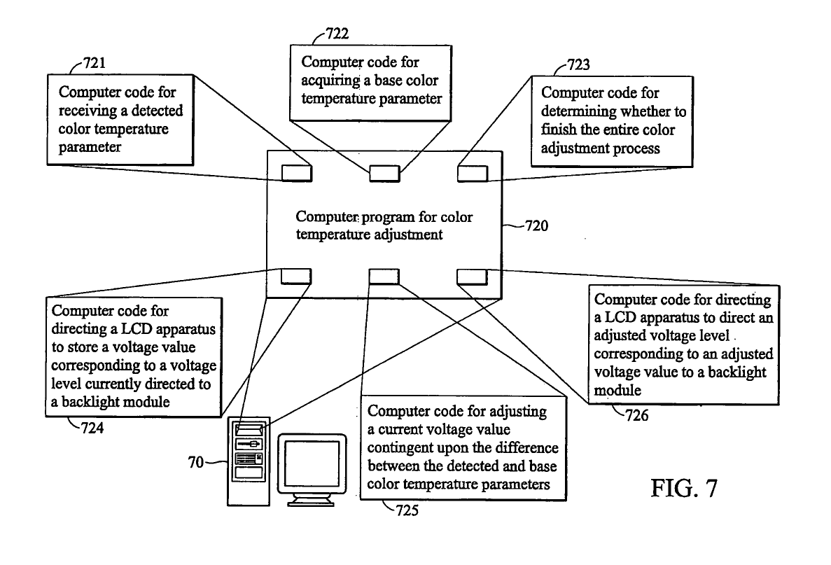

Also disclosed is a storage medium as shown in FIG. 7 storing a computer program 720 providing the disclosed methods of color temperature adjustment. The computer program includes a storage medium 70 having computer readable program code therein for use in a computer system. The computer readable program code comprises at least computer readable program code 721 for receiving a detected color temperature parameter, computer readable program code 722 for acquiring a base color temperature parameter, computer readable program code 723 for determining whether to finish the entire color adjustment process, computer readable program code 724 for directing a LCD apparatus to store a voltage value corresponding to a voltage level currently directed to a backlight module thereof, computer readable program code 725 for adjusting the current voltage value contingent upon the difference between the detected and base color temperature parameters, and computer readable program code 726 for directing a LCD apparatus to direct an adjusted voltage level corresponding to an adjusted voltage value to a backlight module thereof.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system, MS, PDA, MSC, SMSC and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

Note that multiple voltage values respectively corresponding to a color temperature type may be generated and stored in the storage device 27. For example, step S421/S621 may acquire a bluish base color temperature, and subsequently generate and store a voltage value for a bluish color temperature in the storage device 27. Additionally, step S421/S621 may acquire a reddish base color temperature, and subsequently generate and store a voltage value for a reddish color temperature in the storage device 27. Multiple color temperature flags respectively correspond to a voltage value are further stored, indicating that when a voltage level corresponding to a specific voltage value is directed to the backlight module 293, images with a particular color temperature type, such as bluish, reddish and the like, are displayed.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method for color temperature adjustment comprising:
acquiring a first color temperature parameter and a second color temperature parameter;
determining whether the difference between the first and second color temperature parameters falls into an acceptable range; and
storing a first voltage value corresponding to a voltage level currently directed to a backlight module of a display apparatus in a storage device of the display apparatus when the difference between the first and second color temperature parameters falls into the acceptable range,
enabling the display apparatus to direct a voltage level corresponding to the stored voltage value to the backlight module thereof when the display apparatus powers on.

2. The method as claimed in claim 1 wherein the first and second color temperature parameters are measured by CIE chromaticity coordinates.

3. The method as claimed in claim 1 wherein the first color temperature parameter represents color temperature detected by a color temperature metrology apparatus, and the second color temperature parameter represents a base color temperature.

4. The method as claimed in claim 1 further comprising:
determining a second voltage value contingent upon the difference between the first and second color temperature parameters when the difference between the first and second color temperature parameters does not fall into the acceptable range; and
directing a voltage level corresponding to the second voltage value to the backlight module of the display apparatus.

5. The method as claimed in claim 1 wherein the first color temperature parameter corresponds to a color temperature flag, indicating that images with a particular color temperature type are displayed.

6. The method as claimed in claim 5 wherein the storing step further comprises storing the color temperature flag in the storage device of the display apparatus, the color temperature flag corresponding to the first voltage value.

7. The method as claimed in claim 1 wherein the backlight module is composed of a plurality of white light-emitting diodes (LEDs), and the first voltage value corresponds to the voltage level currently directed to the white LEDs.

8. The method as claimed in claim 1 wherein the backlight module is composed of a plurality of red, green and blue light-emitting diodes (LEDs), and the first voltage value comprising three sub-voltage values correspond to voltage levels currently directed to the red, green and blue LEDs.

9. A machine-readable storage medium for storing a computer program which, when executed by a processing unit, performs a method of color temperature adjustment, the method comprising:
acquiring a first color temperature parameter and a second color temperature parameter;
determining whether the difference between the first and second color temperature parameters falls into an acceptable range; and
storing a first voltage value corresponding to a voltage level currently directed to a backlight module of a display apparatus in a storage device of the display apparatus when the difference between the first and second color temperature parameters falls into the acceptable range,
enabling the display apparatus to direct a voltage level corresponding to the stored voltage value to the backlight module thereof when the display apparatus powers on.

10. A display apparatus for color temperature adjustment comprising:
a backlight module;
a storage apparatus storing a first voltage level; and
a processing unit coupled to the backlight module and the storage device, acquiring the first voltage value and directing a voltage level corresponding to the voltage value to the backlight module.

11. The display apparatus as claimed in claim 10 wherein the processing unit acquires a first color temperature parameter and a second color temperature parameter, determines whether the difference between the first and second color temperature parameters falls into an acceptable range, and stores the first voltage value corresponding to the voltage level currently directed to the backlight module in the storage device when the difference between the first and second color temperature parameters falls into the acceptable range.

12. The display apparatus as claimed in claim 11 wherein the first and second color temperature parameters are measured by CIE chromaticity coordinates.

13. The display. apparatus as claimed in claim 11 wherein the first color temperature parameter represents color temperature detected by a color temperature metrology apparatus, and the second color temperature parameter represents a base color temperature.

14. The display apparatus as claimed in claim 11 wherein the processing unit determines a second voltage value contingent upon the difference between the first and second color temperature parameters when the difference between the first and second color temperature parameters does not fall into the acceptable range, and directs a voltage level corresponding to the second voltage value to the backlight module.

15. The display apparatus as claimed in claim 11 wherein the first color temperature parameter corresponds to a color temperature flag, indicating that images with a particular color temperature type are displayed.

16. The display apparatus as claimed in claim 15 wherein the processing unit stores the color temperature flag in the storage device, the color temperature flag corresponding to the first voltage value.

17. The display apparatus as claimed in claim 10 wherein the backlight module is composed of a plurality of light-emitting diodes (LEDs).

18. The display apparatus as claimed in claim 10 wherein the backlight module is composed of a plurality of white light-emitting diodes (LEDs), and the first voltage value corresponds to the voltage level currently directed to the white LEDs.

19. The display apparatus as claimed in claim 10 wherein the backlight module is composed of a plurality of red, green and blue light-emitting diodes (LEDs), and the first voltage value comprising three sub-voltage values correspond to voltage levels currently directed to the red, green and blue LEDs.
